(19) United States
(12) Patent Application Publication
(10) Pub. No.: US 2025/0208974 A1
(43) Pub. Date: Jun. 26, 2025

(54) ANALYSIS RESULT MANAGEMENT DEVICE, ANALYSIS RESULT MANAGEMENT METHOD, AND STORAGE MEDIUM THEREOF

(71) Applicant: DENSO CORPORATION, Kariya-city (JP)

(72) Inventors: Wenhung HUANG, Kariya-city (JP); Yasuhiro HOSHIBA, Nagoya-shi (JP); Hidenori MATSUZAKI, Kariya-city (JP); Mamoru OKUDE, Nagoya-shi (JP); Shimpei URASAWA, Kariya-city (JP)

(21) Appl. No.: 18/991,850

(22) Filed: Dec. 23, 2024

(30) Foreign Application Priority Data
Dec. 26, 2023 (JP) 2023-219695

(51) Int. Cl. G06F 11/3604

(52) U.S. Cl. CPC G06F 11/3604

(57) ABSTRACT

An analysis result management device, which manages static analysis results obtained by different analysis tools, includes: a table including multiple different warning descriptions generated corresponding to a same type of warning and identification information associated with each of the multiple different warning descriptions; an input unit receiving the static analysis results of the source code analyzed by the different analysis tools; a hash value calculation unit calculating a hash value for a target warning, for which the hash value is to be calculated, using the identification information in response to determining that one of the multiple different warning descriptions corresponds to the target warning; a database storing data of the target warning in association with the calculated hash value; and a display unit displaying the data stored in the database.

### CROSS REFERENCE TO RELATED APPLICATION

The present application claims the benefit of priority from Japanese Patent Application No. 2023-219695 filed on Dec. 26, 2023. The entire disclosure of the above application is incorporated herein by reference.

### TECHNICAL FIELD

The present disclosure relates to an analysis result management device that manages analysis results of source code.

### BACKGROUND

In software development, coding mistakes often cause improper operation of software. Although it is possible to prevent the improper operation by reviewing the source code, the number of defects increases dramatically as the size and complexity of the software increases.

### SUMMARY

An analysis result management device, which manages static analysis results obtained by different analysis tools, includes: a table including multiple different warning descriptions generated corresponding to a same type of warning and identification information associated with each of the multiple different warning descriptions; an input unit receiving the static analysis results of the source code analyzed by the different analysis tools; a hash value calculation unit calculating a hash value for a target warning, for which the hash value is to be calculated, using the identification information in response to determining that one of the multiple different warning descriptions corresponds to the target warning; a database storing data of the target warning in association with the calculated hash value; and a display unit displaying the data stored in the database.

### BRIEF DESCRIPTION OF DRAWINGS

Objects, features and advantages of the present disclosure will become apparent from the following detailed description made with reference to the accompanying drawings. In the drawings:

FIG. 1 is diagram showing a functional configuration of an analysis result management device according to a first embodiment;

FIG. 2 is a diagram showing a hardware configuration of the analysis result management device according to the first embodiment;

FIG. 3A is a diagram showing an example of static analysis result data stored in a database;

FIG. 3B is a diagram showing an example of review result data stored in a database;

FIG. 4 is a diagram showing an example of source code that is a target of static analysis;

FIG. 5A is a diagram showing the code used to calculate a hash value of warning in warning line 1;

FIG. 5B is a diagram showing the code used to calculate a hash value of warning in warning line 2;

FIG. 5C is a diagram showing the code used to calculate a hash value of warning in warning line 3;

FIG. 6 is a flowchart showing a calculation process executed by a hash value calculation unit;

FIG. 7A is a diagram showing the code used to calculate a hash value of warning in warning line 1;

FIG. 7B is a diagram showing the code used to calculate a hash value of warning in warning line 2;

FIG. 7C is a diagram showing the code used to calculate a hash value of warning in warning line 3;

FIG. 8 is a diagram showing another example of a hash value calculation executed by a hash value calculation unit;

FIG. 9 is a diagram explaining a calculation process executed by a hash value calculation unit of an analysis result management device according to a second embodiment;

FIG. 10 is a diagram showing a functional configuration of an analysis result management device according to a third embodiment;

FIG. 11 is a diagram showing an example of data stored in a warning correspondence table;

FIG. 12 is a diagram explaining a calculation process executed by a hash value calculation unit;

FIG. 13 is a diagram showing an example of a screen which displays an analysis result managed by an analysis result management device;

FIG. 14 is a diagram explaining a calculation process executed by a hash value calculation unit of an analysis result management device according to a third embodiment; and

FIG. 15 is a diagram showing types of inputs used for calculating hash values in different calculation methods.

### DETAILED DESCRIPTION

In order to detect such errors before performing a test on the program, static analysis systems have been developed and are on sale. The static analysis system analyzes software source files syntactically and semantically without actually executing the software source files, and outputs warnings for description of source codes that may contain bugs. This kind of analysis system outputs the information such that a software developer can use the output information to correct the source code.

The analysis system outputs analysis result of source code. In some cases, the analysis result contains a huge number of warnings. When multiple versions of software programs are created in the software development and a warning that has already been confirmed in a previous version is issued again in subsequent version, the software developer needs to confirm the warning again even though the warning has already been confirmed in the previous version. This may decrease work efficiency. A related art discloses a technique for suppressing warning messages by comparing, between the previous version of software code and the subsequent version of software code, line and column numbers of source code, an analysis target syntax, and components included in the syntax.

There is also known a system that calculates a hash value for a set of source code description content and tool detection result, and manages the analysis result using the hash value. Using the hash value makes it easy to compare analysis results for different versions of source code. Since the analysis results with the same hash value can be treated as the same, it enables reuse of the analysis result. The warnings can be searched for using the hash value, thereby increasing work efficiency and management accuracy.

When analyzing the source code, multiple different static analysis systems may be used. Since multiple static analysis systems perform analysis from different perspectives, a detection accuracy of errors for the source code can be improved.

When using the multiple different static analysis systems to detect respective errors, multiple different warnings may be output for the same type of code error. This may increase the number of warnings and make it more difficult for a software developer to check the contents of the warnings.

According to an aspect of the present disclosure, an analysis result management device manages data of static analysis results obtained by analyzing source code using different analysis tools. The analysis result management device includes a table including multiple different warning descriptions, which are generated by analyzing a same type of warning by the different analysis tools, the table further including identification information that is associated with each of the multiple different warning descriptions. The analysis result management device includes an input unit receiving the data of static analysis results of the source code analyzed by the different analysis tools. The analysis result management device includes a hash value calculation unit acquiring warning related data, which includes information related to a target warning included in the received static analysis results, and calculating a hash value for the target warning by referring to the table. The target warning is a warning for which the hash value is to be calculated. The hash value calculation unit calculates, in response to determining that one of the multiple different warning descriptions corresponds to the target warning, the hash value for the target warning using the identification information associated with the one of the multiple different warning descriptions in the table, without using the one of the multiple different warning descriptions. The analysis result management device includes a database storing data of the target warning in association with the hash value calculated for the target warning, and a display unit displaying the data stored in the database.

According to another aspect of the present disclosure, a computer-implemented analysis result management method manages, using an analysis result management device, data of static analysis results obtained by analyzing source code using different analysis tools. The analysis result management method includes: preparing, with the analysis result management device, a table including multiple different warning descriptions, which are generated by analyzing a same type of warning by the different analysis tools, the table further including identification information that is associated with each of the multiple different warning descriptions; receiving, with the analysis result management device, the data of static analysis results of the source code analyzed by the different analysis tools; acquiring, with the analysis result management device, warning related data, which includes information related to a target warning included in the received static analysis results; calculating a hash value for the target warning by referring to the table, the target warning being a warning for which the hash value is to be calculated; in response to determining that one of the multiple different warning descriptions corresponds to the target warning, calculating the hash value for the target warning using the identification information associated with the one of the multiple different warning descriptions in the table, without using the one of the multiple different warning descriptions; storing, in a database, data of the target warning in association with the hash value calculated for the target warning; and displaying the data stored in the database.

According to another aspect of the present disclosure, a computer-readable non-transitory storage medium stores a computer program, which includes instructions for managing data of static analysis results obtained by analyzing source code using different analysis tools. The instructions of the computer program includes: preparing a table including multiple different warning descriptions, which are generated by analyzing a same type of warning by the different analysis tools, the table further including identification information that is associated with each of the multiple different warning descriptions; receiving the data of static analysis results of the source code analyzed by the different analysis tools; acquiring warning related data, which includes information related to a target warning included in the received static analysis results; calculating a hash value for the target warning by referring to the table, the target warning being a warning for which the hash value is to be calculated; in response to determining that one of the multiple different warning descriptions corresponds to the target warning, calculating the hash value for the target warning using the identification information associated with the one of the multiple different warning descriptions in the table, without using the one of the multiple different warning descriptions; storing, in a database, data of the target warning in association with the hash value calculated for the target warning; and displaying the data stored in the database.

According to the above aspects of present disclosure, a display of duplicated warnings for different static analysis results analyzed by multiple different analysis tools can be suppressed, thereby enabling a software developer to appropriately evaluate the different analysis results of source code.

The following will describe an analysis result management device according to the present disclosure with reference to the drawings.

### First Embodiment

### (Overall Configuration of Analysis Result Management Device)

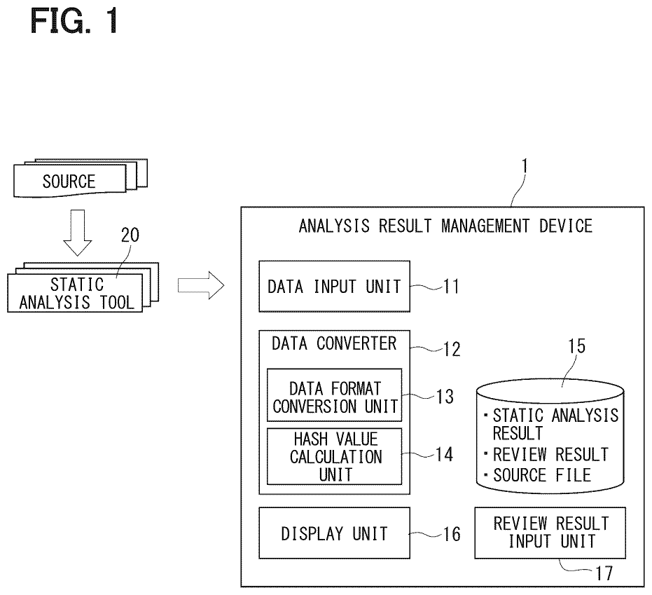

FIG. 1 is a diagram showing a functional configuration of an analysis result management device 1 according to the present embodiment. The analysis result management device 1 receives, as an input, analysis result of software source code, which is generated by a static analysis tool 20, and manages the received static analysis result data. The analysis result management device 1 receives multiple records of static analysis results from multiple static analysis tools 20.

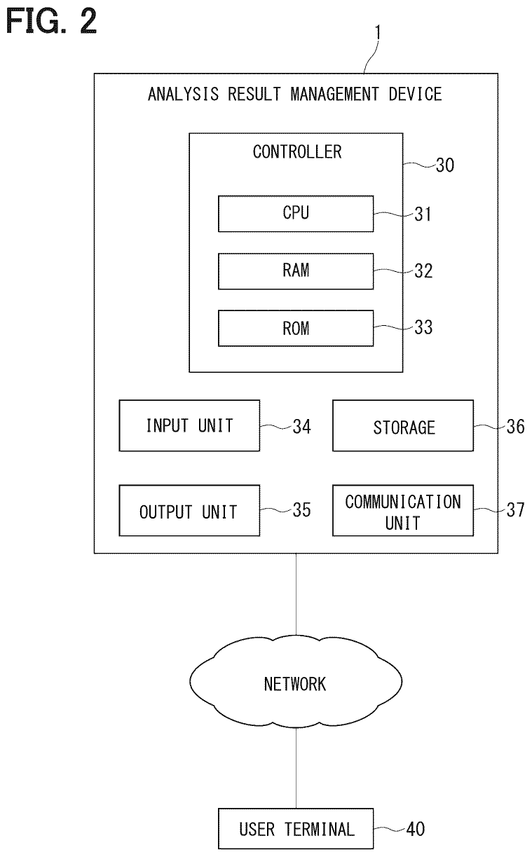

FIG. 2 is a diagram showing a hardware configuration of the analysis result management device 1 according to the present embodiment. The analysis result management device 1 is provided on a network. The analysis result management device 1 and a user terminal 40 are capable of communicating with one another through the network. A type of the network is not limited to a specific type. For example, the network may be an internet, an in-house intranet, or the like. In the present embodiment, as an example, the analysis result management device 1 is provided on a network. As another example, the analysis result management device 1 may be provided by a local personal computer (hereinafter referred to as local PC). In this case, the local PC has the functions of analysis result management device 1 and the user terminal 40.

The analysis result management device 1 includes a controller 30, which has a CPU 31, a RAM 32, and a ROM 33. The analysis result management device 1 further includes an input unit 34, an output unit 35, a storage 36, and a communication unit 37. By executing programs stored in the ROM 33, the functions of analysis result management device 1 are implemented. The functions of analysis result management device 1 will be described later. The programs executed by the analysis result management device 1 are also included in the scope of the present disclosure.

A user such as a software developer accesses the analysis result management device 1 through a web browser using the user terminal 40. The user terminal 40 transmits data of static analysis result to the analysis result management device 1. The analysis result management device 1 manages the data of static analysis result.

Returning to FIG. 1, the functions of analysis result management device 1 will be described. The analysis result management device 1 includes a data input unit 11, a data converter 12, a database 15, a display unit 16, and a review result input unit 17.

The data input unit 11 receives input of static analysis result data, which indicates static analysis result of source file. The static analysis result is generated by a static analysis tool 20. The static analysis result data is warning data of source code description that may contain bugs. This static analysis result data indicates a location of syntax error within the source code and a type of the syntax error. The data input unit 11 also receives input of source file data. The reason why the source file is input to the data input unit will be described later. The analysis result management device 1 of the present embodiment also uses the source code data to calculate a hash value.

There are various types of static analysis tools 20. The data input unit 11 receives multiple types of data analyzed by different static analysis tools 20. The static analysis results vary depending on the type of static analysis tool 20. A description that is detected as a warning by one static analysis tool 20 may not be detected as a warning by another static analysis tool 20. This is due to the specifications of static analysis tools 20 are different from one another, and different static analysis tools 20 are good at different analyzing fields. By incorporating multiple static analysis results from multiple static analysis tools 20, a highly accurate review can be performed. The data input unit 11 transfers the input static analysis result data to the data converter 12. The data input unit 11 stores the source file in the database 15.

The data converter 12 includes a data format conversion unit 13 and a hash value calculation unit 14. The static analysis result data input to the data input unit 11 may have different items and different formats (for example, text data, HTML format, etc.) depending on the type of static analysis tool 20. The data format conversion unit 13 has a function of converting different data formats of different static analysis result data into a common format.

The hash value calculation unit 14 has a function of calculating a hash value of a warning included in the static analysis result data. The hash value is specific data calculated based on warning related data and code included in a warning related line. The warning related data is data related to the warning, and the warning related line is a line related to the warning. The hash value is used as identification information to identify the warning. The method of calculating the hash value will be described later in detail.

By using the hash value as identification information of warning, the same warning can be easily identified across different versions of source files. By using the hash value, a warning that has already been reviewed can be avoided from being reviewed again, thereby significantly reducing the time required to review the source code.

The database 15 stores static analysis results, review results, and source files. The data format of static analysis result data is converted by the data converter 12. The static analysis result data is assigned with a hash value, which is calculated for the warning, and the static analysis result data assigned with the hash value is stored in the database 15.

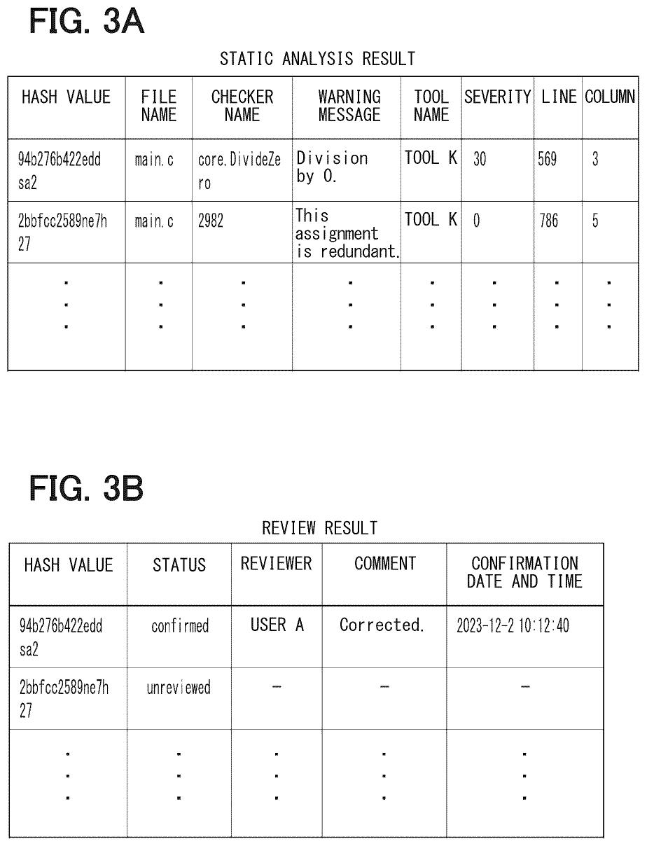

FIG. 3A is a diagram showing an example of the static analysis result data stored in the database 15. The static analysis result data includes a file name, a checker name, a warning message, a tool name, a severity, a line, and a column, which are associated with a hash value. The hash value is identification information that identifies the warning, and is calculated based on the warning related data and code included in the warning related line.

The file name is a name of the source file, which is a target of static analysis. The checker name is a name of a checker, which detected the warning. The static analysis tool 20 has multiple checker algorithms, and searches for code that may contain bugs by executing the multiple checker algorithms, and outputs the warning. The warning message is a message for informing the user of the warning contents.

The tool name is a name of the static analysis tool 20, which detected the warning. The severity is data that represents a seriousness of the warning. The severity is expressed within a number range of 0 and 30, and the higher the number, the more severe the warning. The line and column are data that identify the location of code associated with the warning. The line indicates a line number where the code associated with the warning starts. The column indicates a column number of the code associated with the warning within in the file. Note that the above-described configuration is an example of static analysis result data. The static analysis result data may include data other than those shown in FIG. 3A.

Among the static analysis result data shown in FIG. 3A, the description formats of the checker name, warning message, tool name, and severity vary depending on the static analysis tool 20, and the same code error may be expressed in different formats.

FIG. 3B is a diagram showing an example of review result data stored in the database 15. The review result data includes a status, a reviewer, a comment, and confirmation date and time, which are association with a hash value. The hash value corresponds to the hash value included in the static analysis result data, and identifies the warning. The status indicates a review status of the warning identified by the hash value. For example, “confirmed” indicates that the warning has been confirmed, and “unreviewed” indicates that the warning has not yet been reviewed. The reviewer indicates a name of user who reviewed the warning and changed status of the warning. The comment is a comment about what action is taken against the warning when the warning is reviewed by the reviewer. The confirmation date and time is data on the date and time when the contents of warning is confirmed. Note that the above-described configuration is an example of review result data. The review result data may include data other than those shown in FIG. 3B.

The display unit 16 has a function of displaying the analysis result data, which is stored in the database 15, on the user terminal 40. Specifically, in response to a request from the user terminal 40, the display unit reads the analysis result data from the database 15, and transmits the analysis result data to the user terminal 40. The user terminal 40 displays the analysis result data transmitted from the display unit 16.

When the review result input unit 17 receives the review result data from the user terminal 40, the review result input unit 17 stores the received review result in the database 15 in association with the hash value indicating the same warning. Specifically, the review result input unit 17 updates the status, the reviewer, the comment, and the confirmation date and time of the warning, which is identified by the hash value.

### (Calculation of Hash Value)

The following will describe a calculation process of hash value by the hash value calculation unit 14. The hash value calculation unit 14 calculates a hash value using, as inputs, the warning related data and the code related to warning (hereinafter referred to as warning related code). The warning related data includes the file name of source file, the name of checker that performed the analysis, and the warning message. Note that the above-described configuration is an example the warning related data used to calculate the hash value. The warning related data may adopt other data related to the warning to calculate the hash value.

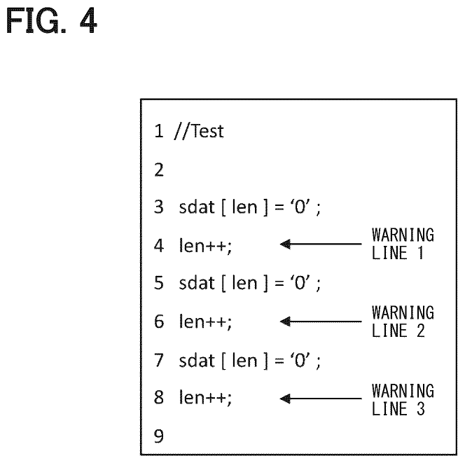

FIG. 4 is a diagram showing an example of source code, which is a target of static analysis. The calculation of hash value will be described using the code shown in FIG. 4 as an example. In the example shown in FIG. 4, there may be an error in the code “len++”, which is detected as a warning. The hash value calculation unit 14 calculates a hash value using, as inputs, the warning related data as well as the warning related code “len++”.

Note that the line number is not used in calculation of the hash value. Since the line number is not used in the calculation of hash value, even when the line number in a different version of source code is shifted by introduction of a blank line, the hash value maintains the same and the user can understand that the hash value indicates the same warning. However, when the line number is not used in the calculation of hash value, when the same warning exists in multiple lines, the hash value corresponding to the multiple warnings will be the same as the hash value corresponding to a single warning.

Referring to FIG. 4, the codes in warning lines 1, 2, and 3 are the same. Therefore, the contents of warning related data (specifically, the file name of source file, the name of checker that performed the analysis, and the warning message) are the same for the warnings in warning lines 1, 2, and 3. In this case, the hash values for the codes in warning lines 1 to 3 are the same, and the same identification information will be assigned to the warnings in warning lines 1 to 3, and they will be treated as a single warning. Although there is a consideration that treating the same warnings as a single warning is acceptable, the analysis result management device 1 of the present embodiment is configured to handle multiple warnings as separate warnings even though they have the same warning contents. The hash value calculation unit 14 calculates a hash value so as to distinguish the same warnings as shown in FIG. 4.

When a hash value (referred to as a first hash value), which is calculated using, as inputs, the warning related data and the code included in the warning related line, is same as any of the previously calculated hash values, the hash value calculation unit 14 calculates a hash value (referred to as a second hash value) using, as input, the code between a line, from which duplication of hash value is first determined to start, to a line, which is related to the warning. Then, the second hash value is set as the hash value corresponding to the warning.

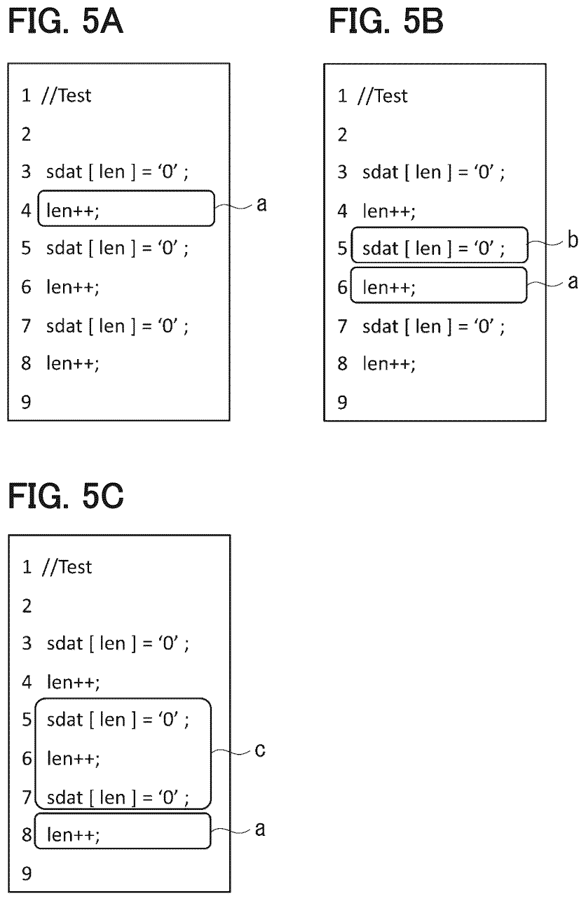

FIG. 5A to FIG. 5C are diagrams for explaining the codes to be used in calculation of hash values for the warnings in warning lines 1 to 3. In the description of FIG. 5A to FIG. 5C, the code is used to calculate the hash value. But as described above, the warning related data, which is used as input for calculation of hash value, may be appropriately changed. FIG. 5A shows the code used to determine the hash value of the warning in warning line 1. The code in the fourth line enclosed by a box, which is indicated by a, is used as input to calculate the hash value.

FIG. 5B shows the code used to determine the hash value of the warning in warning line 2. In addition to the code enclosed in box a, the code in the fifth line enclosed in box b, which is sandwiched between warning line 1 and warning line 2, is used as an input for calculating the hash value. The duplication of hash value is determined to start from the warning line 1. FIG. 5C shows the code to be use for calculation of hash value of the warning in warning line 3. In addition to the code enclosed in box a, the code from lines 5 to 7 enclosed in box c, which is sandwiched between warning line 1 and warning line 3, is used as an input for calculating the has value. The duplication of hash value is determined to start from the warning line 1. As shown in FIG. 5A to FIG. 5C, even when the same warning is detected for the code “len++”, the hash values are distinguished by changing the range of code used to calculate the hash value.

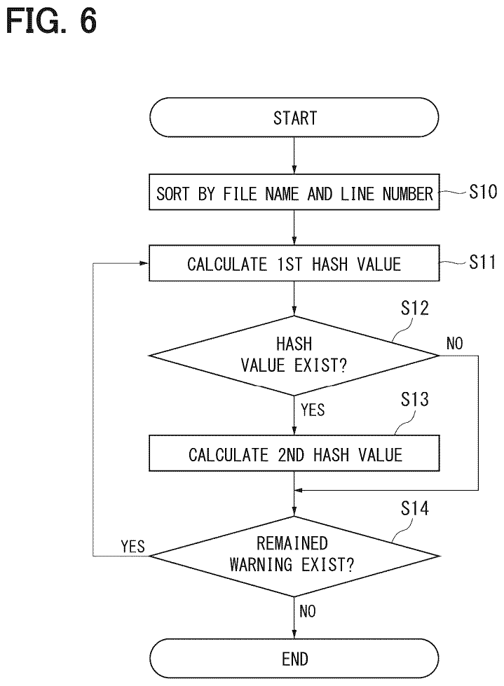

FIG. 6 is a flowchart showing a calculation process executed by the hash value calculation unit 14. The hash value calculation unit 14 first sorts all warnings in the static analysis result data by file name and line number of the warning (S10). Next, the hash value calculation unit 14 calculates a first hash value using, as inputs, the warning related data and the code in the waring related line (S11), and determines whether the first hash value is identical to a hash value, which has been calculated before (S12).

When the same hash value as the first hash value exists (YES in S12), the hash value calculation unit 14 calculates the second hash value using (i) the warning related data, (ii) the code in the warning related line, and (iii) the code between the line where the hash value is first duplicated and the warning related line being calculated (S13). Then, the has value calculation unit 14 sets the second hash value as the hash value of the warning. At this time, spaces, comments, and other parts that do not directly affect the warning may or may not be used in the calculation of the hash value. Next, the hash value calculation unit 14 determines whether there is a remained warning for which the hash value has not yet been calculated (S14). When a warning for which a hash value has not yet been calculated is remained (YES in S14), the process returns to S11 to calculate a first hash value for the remaining warning.

In S12, when determining whether a hash value identical to the currently calculated first hash value exists or not, in response to determining that the same hash value does not exist (NO in S12), the first hash value is used as the hash value of the warning, which is the calculation target. In S14, when determining whether a warning for which the hash value has not yet been calculated is remained or not, in response to determining that there is no warning for which the hash value has not yet been calculated (NO in S14), the calculation process of hash value for the corresponding static analysis result data is terminated.

The analysis result management device 1 and the analysis result management method according to the first embodiment have been described above. In the first embodiment, when the calculated first hash value is same as an already existing hash value, the analysis result management device 1 can avoid duplication of hash value by calculating the second hash value using, as inputs, the code from the warning line where the hash value is first duplicated to the warning line corresponding to calculation target. Since the code before the line where duplication of first hash value occurs does not affect the calculation of second hash value, even though a correction is made before, it does not affect the analysis of the difference between the different versions. This configuration enables proper management of warnings.

The software under development is frequently changed with upgrade of versions. For this reason, it is important to identify changes and problems. The analysis result management device 1 of the present embodiment manages the analysis result of source code before and after the upgrade of software under development, and identifies changes and problems. By elaborating the method for managing the analysis results, it is possible to distinguish different warnings from one another and improve undetected problems.

In the first embodiment described above, when calculating the second hash value, the code from the warning line where the hash value is first duplicated to the warning line corresponding to the calculation target is used as input. Alternatively, a different range of code may be used as input of the hush value calculation. For example, the hash value may be calculated using, as input, the code from the first line of source code to the warning line that corresponds to the calculation target.

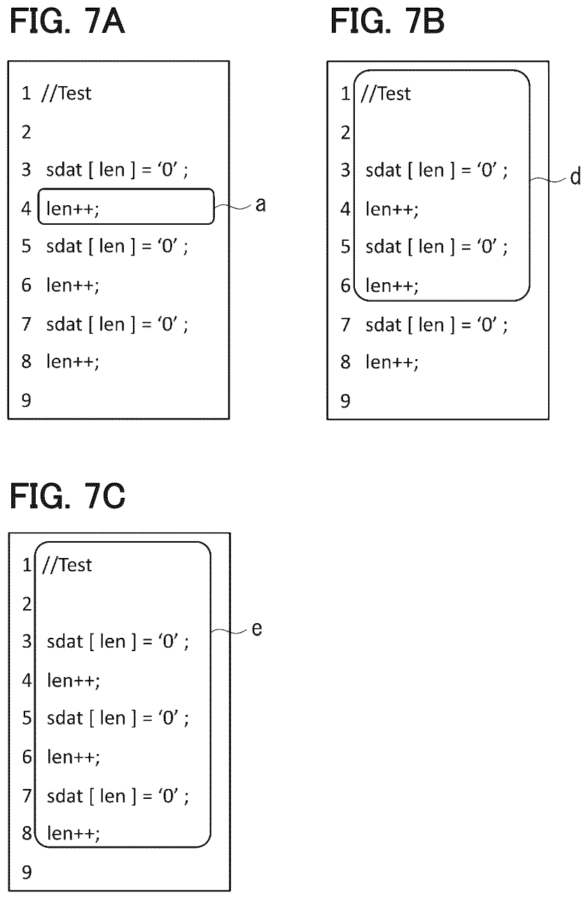

FIG. 7A to FIG. 7C are diagrams showing an example of code used in calculation of the second hash value. FIG. 7A to FIG. 7C correspond to FIG. 5A to FIG. 5C, respectively. FIG. 7A to FIG. 7C show calculations of hash values for the warning lines 1 to 3.

In FIG. 7A, since the hash value of warning line 1 is not duplicated, the warning related code in line 1 is used as an input to calculate the hash value. When calculating the hash value of warning line 2, the first hash value calculated using only the code in warning line 2 is same as the hash value calculated for the warning line 1. Thus, as shown in FIG. 7B, the hash value calculation unit 14 calculates a second hash value using, as input, the code in the range enclosed by a box d from line 1 of the source code to the warning line 2.

When calculating the hash value of warning line 3, the first hash value calculated using only the code in warning line 3 is same as the hash value calculated for the warning line 1. Thus, as shown in FIG. 7C, the hash value calculation unit 14 calculates a second hash value using, as input, the code in the range enclosed by a box e from line 1 of the source code to the warning line 3. With this configuration, it is possible to prevent duplication of hash values.

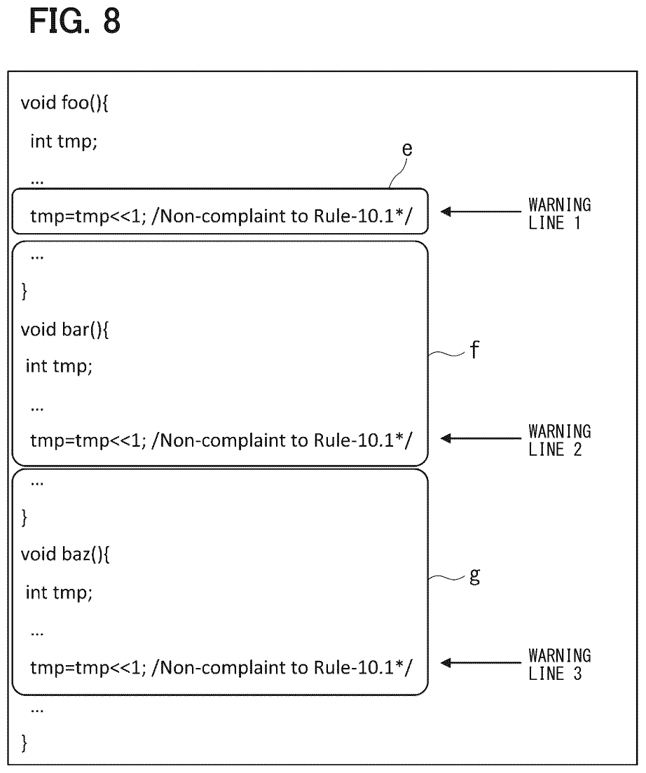

As another example of the range of code to be used to calculate the hash value, the code from the previous warning line to the warning line of calculation target may be used as input. FIG. 8 shows an example of such calculation of hash value. In FIG. 8, the three lines, which begin with “tmp=”, correspond to warning lines 1, 2, and 3.

In FIG. 8, since the hash value of warning line 1 is not duplicated, the code in warning line 1 is used as an input to calculate the hash value. When calculating the hash value of warning line 2, the first hash value calculated using only the code in warning line 2 is same as the hash value calculated using the code in warning line 1. Thus, the hash value calculation unit 14 calculates a second hash value using, as input, the code in the range enclosed by a box f from the line next to warning line 1 to warning line 2.

When calculating the hash value of warning line 3, the first hash value calculated using only the code in warning line 3 is same as the hash value of calculated using the code in warning line 1. Thus, the hash value calculation unit 14 calculates a second hash value using, as input, the code in the range enclosed by a box g from the line next to the previous warning line 2 to warning line 3. With this configuration, it is possible to suppress duplication of hash values.

### Second Embodiment

The following will describe an analysis result management device according to a second embodiment of the present disclosure. The basic configuration of analysis result management device of the second embodiment is same as that of the analysis result management device 1 of the first embodiment (see FIG. 1 and FIG. 2). The analysis result management device according to the second embodiment differs from the analysis result management device according to the first embodiment in that the analysis result management device according to the second embodiment calculates the hash value with consideration of flow information related to the warning line.

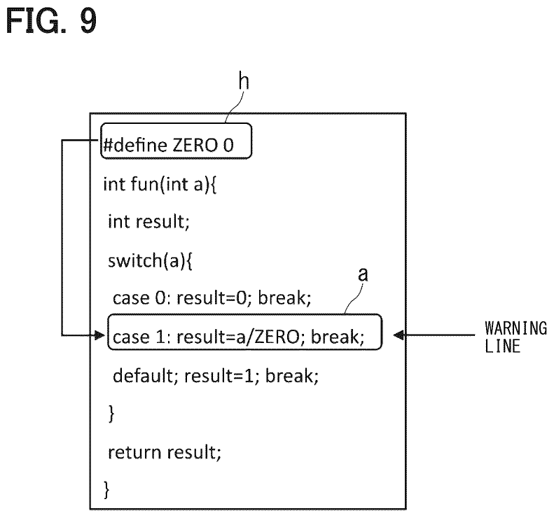

FIG. 9 is a diagram for explaining the calculation process executed by the hash value calculation unit 14 of the analysis result management device according to the second embodiment. In FIG. 9, the warning line is “case 1: result=a/ZERO; break;” enclosed by a box a, and warns dividing a by ZERO may be an error. Here, the fact that ZERO is 0 is defined by “#define ZERO 0” enclosed in box h. That is, the variable in the code enclosed in box a references the code enclosed in box h, and these two lines are related with one another. When a problem is discovered in source code as a warning, it may be necessary to view a processing flow that led to the point where the problem occurred. In the present disclosure, such movement through the source code is referred to as “flow information.”

When calculating the hash value for the warning line enclosed in box a, the hash value calculation unit 14 calculates the hash value using, as input, the code in the warning line as well as the code in the line enclosed by box h.

According to the second embodiment of the analysis result management device, the hash value is calculated with consideration of not only the warning message and source code, but also the flow information related to the warning line, thereby suppressing the occurrence of undetected warning and improving the management quality of analysis results.

In the present embodiment, in addition to the configuration of the analysis result management device 1 of the first embodiment, the hash value is calculated with further consideration of the flow information. However, the hash value calculation method that avoids duplication of hash value described in the first embodiment is not necessarily required for the calculation of hash value with consideration of flow information as described in the second embodiment. Therefore, in an analysis result management device that allows the same hash value to be assigned to multiple warnings of the same type, the hash value may be calculated with consideration of the flow information.

### Third Embodiment

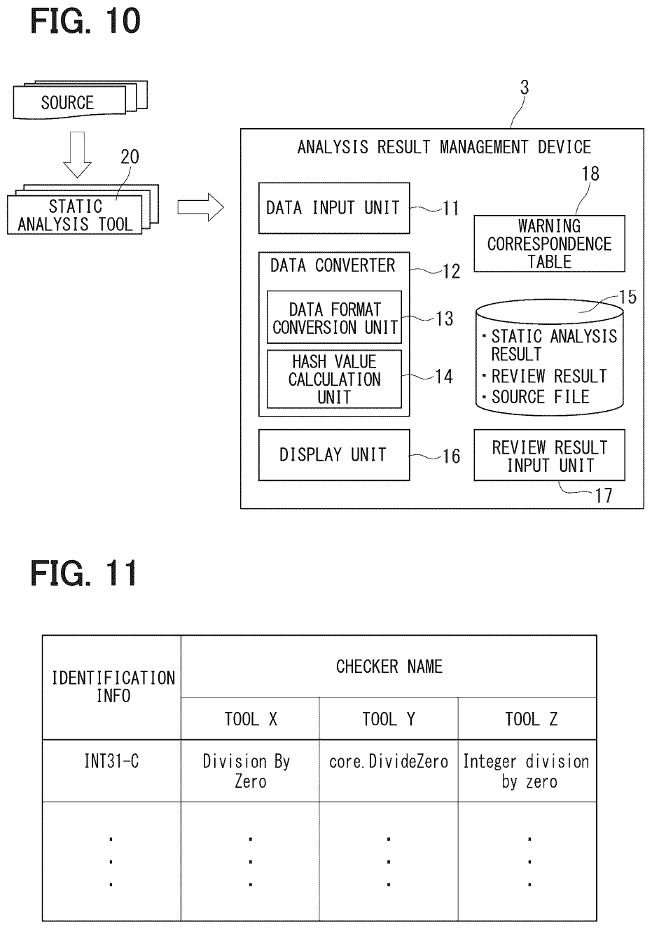

FIG. 10 is a diagram showing a functional configuration of an analysis result management device 3 according to a third embodiment. The basic configuration of analysis result management device 3 of the third embodiment is similar to that of the analysis result management device 1 of the first embodiment. The analysis result management device 3 of the third embodiment is provided with a warning correspondence table 18. The warning correspondence table 18 is a table showing the correspondence between checkers that detect the same type of warnings in static analysis result data generated by multiple static analysis tools 20.

FIG. 11 is a diagram showing an example of data stored in the warning correspondence table 18. The warning correspondence table 18 shows the correspondence among the checker names of the static analysis tools 20, that is, tool X, tool Y, and tool Z. In the example shown in FIG. 11, “Division By Zero” in tool X, “core. DivideZero” in tool Y, and “Integer division by zero” in tool Z are correlated with one another. The warning correspondence table 18 correlates identification information with the checker name of each tool. In FIG. 11, the identification information of “INT31-C” is a string given to a rule that “ensures that integer conversion do not result in data loss or misinterpretation” defined in the CERT C coding standard. In this way, a meaningful character string may be used as the identification information. Alternatively, meaningless random information may also be used when there is no duplication. In FIG. 11, the warning correspondence table 18 stores correspondence among the checker names of three analysis tools. Instead of checker names of three analysis tools, checker names of two, four or more analysis tools may be correlated with one another using the identification information. When an analysis tool is added, the checker name of the new analysis tool can be registered in the warning correspondence table 18.

When calculating the hash value of warning, the hash value calculation unit 14 determines whether the checker name that detected the warning, which corresponds to the calculation target, is recorded in the warning correspondence table 18. In response to determining that the checker name is recorded in the warning correspondence table 18, the identification information corresponding to that checker name is read out, and the hash value is calculated using the identification information as input instead of the checker name.

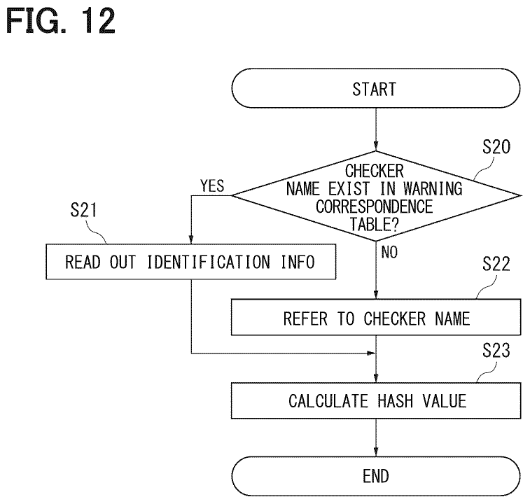

FIG. 12 is a diagram for explaining the calculation process executed by the hash value calculation unit 14. The flow shown in FIG. 12 is a detailed process of the calculation of first hash value (S11) or calculation of the second hash value (S13) in the hash value calculation flow shown in FIG. 6.

When calculating the hash value, the analysis result management device 3 of the third embodiment determines whether the checker name of the checker, which detected the calculation target warning, exists in the warning correspondence table 18 (S20). In response to determining that the checker name exists in the warning correspondence table 18, the process reads the identification information from the warning correspondence table 18 (S21), and calculates the hash value using the identification information as input, instead of the checker name of above-described warning related data (S23). That is, the file name of source file and the identification information are used as warning related data. In the analysis result management device 1 of the first embodiment, when calculating the hash value, the file name of source file, the name of checker that performed the analysis, and the warning message are used as the warning related data. In the present embodiment, the warning message is not used.

When the name of checker that detected the calculation target warning does not exist in the warning correspondence table 18 (NO in S20), the checker name is referenced (S22) and the hash value is calculated (S23). That is, the file name of source file and the checker name are used, as the warning related data, to calculate the hash value.

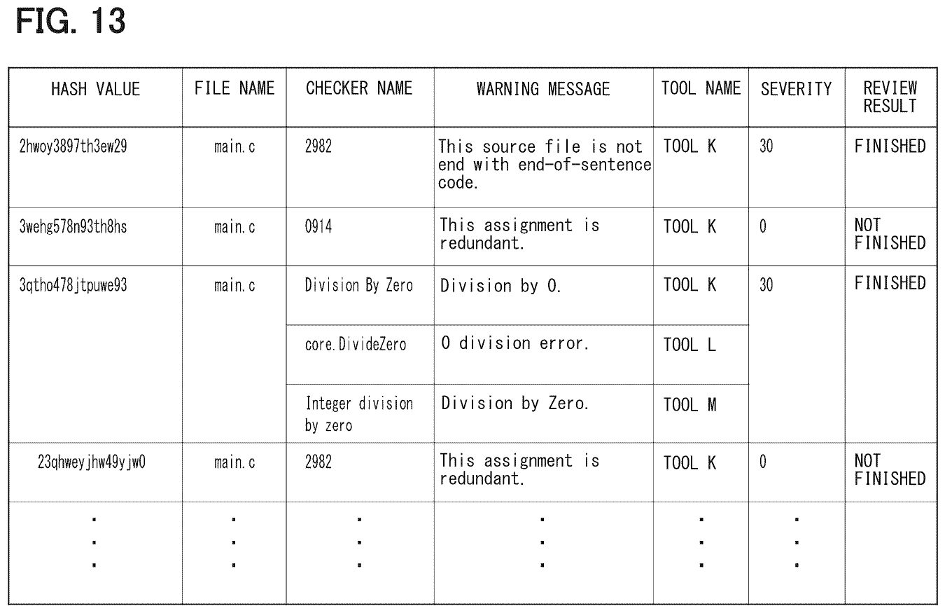

FIG. 13 is a diagram showing a display example indicating the analysis result managed by the analysis result management device 3. In the analysis result, the hash value that identifies the warning is correlated with the file name of source file in which the warning is detected, the name of checker that detected the warning, the warning message, the name of static analysis tool 20 that detected the warning, the severity indicating the seriousness of warning, and review result data of the warning.

In the present embodiment, when warnings detected by multiple static analysis tools 20 are related to the same code, they are output as a single warning. Specifically, data of three tools, that is, tool K, tool L, and tool M are correlated to the same hash value in the third row as shown in FIG. 13. Although the warnings are detected by three different static analysis tools 20, they are treated as a single warning since they correspond to the same code. It is not necessary to deal with warnings for each static analysis tool 20. By inputting the review result once, it is possible to set a status indicating that the warning has been dealt with.

Conventionally, when multiple static analysis tools 20 are used, there is a problem that same warnings are displayed by multiple times, and determination of the same warnings is a time-consuming work. According to the present embodiment, it is possible to determine the results of different static analysis tools 20 as the same warning, thereby making verification more efficient.

As shown in FIG. 13, although warnings detected by checkers of static analysis tools are treated as a single warning, the static message and tool name information remain as data for each static analysis tool 20. Thus, it is possible to refer to the static analysis result generated by each static analysis tool 20.

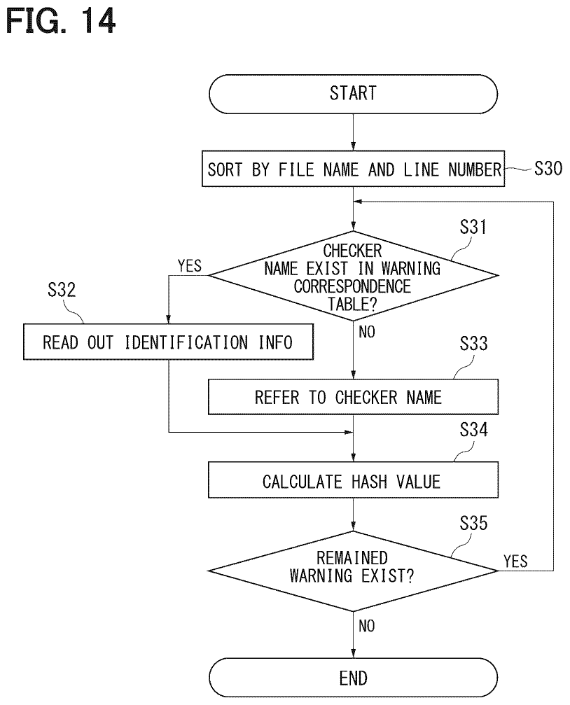

According to the present embodiment, in the calculation of hash value by the analysis result management device of the first embodiment, the same hash value is assigned to the same warnings detected by multiple static analysis tools by referring to the warning correspondence table 18 (see FIG. 12). The technology described in the present embodiment for recognizing warnings from multiple static analysis tools as the same warning does not necessarily require the configuration of the first embodiment as a premise. The hash value calculation unit 14 may calculate the hash value as shown in FIG. 14.

FIG. 14 illustrates a calculation process hash value executed by the analysis result management device 3 according to the third embodiment. The hash value calculation unit 14 first sorts the source files by file name and line number (S30). Next, the hash value calculation unit determine whether the name of checker that detected the calculation target warning exists in the warning correspondence table 18 (S31). In response to determining that the checker name exists in the warning correspondence table 18 (YES in S31), the hash value calculation unit reads the identification information from the warning correspondence table 18 (S32), and calculates the hash value using the identification information as input, instead of the checker name of the warning related data (S34).

When the name of checker that detected the calculation target warning does not exist in the warning correspondence table 18 (NO in S31), the checker name is referenced (S33) and then the hash value is calculated (S34).

Next, the hash value calculation unit 14 determines whether there remains any warning for which the hash value has not yet been calculated (S35). In response to determining that there remains any warning for which the hash value has not yet been calculated (YES in S35), the process returns to S31 and determines whether the name of checker that detected the calculation target warning exists in the warning correspondence table 18. In response to determining that there is no warning for which the hash value has not yet been calculated (NO in S35), the calculation process of hash value for the corresponding static analysis result data is terminated.

The technique described in the present embodiment may also be applied to the analysis result management device of the second embodiment.

### Modifications

The analysis result management device of the present disclosure has been described in detail using multiple embodiments. The analysis result management device of the present disclosure is not limited to the above-described embodiments. The analysis result management device may prepare multiple calculation methods for calculating hash values. The analysis result management device may select one calculation method that matches the development policy of product project, from multiple calculation methods.

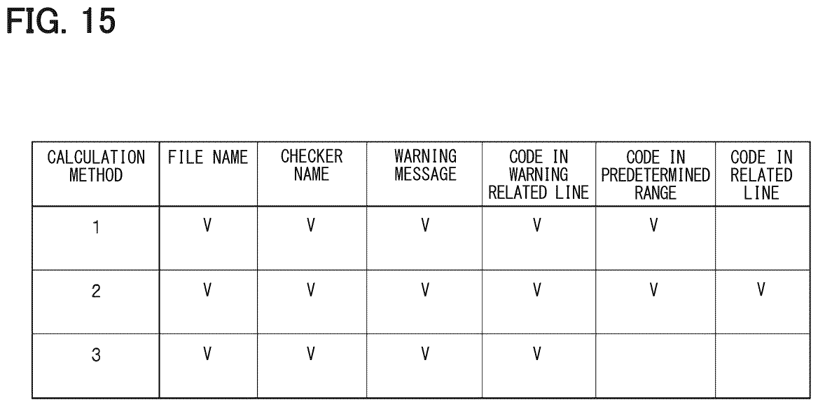

FIG. 15 is a diagram showing types of inputs used in calculation of hash value in multiple calculation methods. In the example shown in FIG. 15, three calculation methods 1, 2, and 3 are described. FIG. 15 shows the data used as input for each calculation method. Specifically, data containing the check mark “V” is used to calculate the hash value.

The inputs used in calculation method 1 for hash value calculation include file name, checker name, warning message, code in a corresponding line, and code within a predetermined range when the hash value is duplicated. The code in the corresponding line indicates the code in the warning line. The inputs used in calculation method 2 for hash value calculation include file name, checker name, warning message, code in a corresponding line, code in a relevant line, and code within a predetermined range when the hash value is duplicated. The inputs used in calculation method 3 for hash value calculation include file name, checker name, warning message, code in a corresponding line. In calculation method 3, although duplication of hash value occurs, the code within the predetermined range is not used. That is, calculation method 3 allows duplication of hash value.

By preparing the calculation methods 1, 2, and 3, each of which allows duplication of hash value, the user may be allowed to select a proper calculation method from the prepared options. Specifically, data on calculation methods 1 to 3 is transmitted to the user terminal 40, and the calculation methods are displayed on the user terminal 40. The analysis result management device 1 includes a selection receiving unit that receives a selection of the calculation method. Specifically, the selection receiving unit receives the selection data of calculation method inputted at the user terminal 40, and sets the calculation method in accordance with the selection data.

The analysis result management device 3 of the third embodiment may prepare a calculation method that uses the warning correspondence table 18 and a calculation method that does not use the warning correspondence table 18. As described above, in the warning correspondence table 18, the analysis results by multiple static analysis tools 20 are correlated with one another. Thus, the user may be allowed to select one calculation method for calculating the hash value from the prepared options.

What is claimed is:

1. An analysis result management device managing data of static analysis results obtained by analyzing source code using different analysis tools, the analysis result management device comprising:
a table including multiple different warning descriptions, which are generated by analyzing a same type of warning by the different analysis tools, the table further including identification information that is associated with each of the multiple different warning descriptions;
an input unit receiving the data of static analysis results of the source code analyzed by the different analysis tools;
a hash value calculation unit acquiring warning related data, which includes information related to a target warning included in the received static analysis results, and calculating a hash value for the target warning by referring to the table, wherein the target warning is a warning for which the hash value is to be calculated, the hash value calculation unit calculates, in response to determining that one of the multiple different warning descriptions corresponds to the target warning, the hash value for the target warning using the identification information associated with the one of the multiple different warning descriptions in the table, without using the one of the multiple different warning descriptions;
a database storing data of the target warning in association with the hash value calculated for the target warning; and
a display unit displaying the data stored in the database.

2. The analysis result management device according to claim 1, further comprising
a review result input unit receiving a review result of the target warning,
wherein the review result input unit stores, in the database, data of the received review result in association with the hash value calculated for the target warning.

3. The analysis result management device according to claim 2, wherein,
when two or more of the multiple different warning descriptions correspond to a same hash value, the display unit displays the two or more of the multiple different warning descriptions in association with the same hash value.

4. The analysis result management device according to claim 2, further comprising
a selection receiving unit receiving a selection of a calculation method of the hash value, which allows or does not allow a same hash value for different static analysis results,
wherein the hash value calculation unit calculates the hash value using warning related data included in each of the different static analysis results input from the different analysis tools, without referring to the table.

5. The analysis result management device according to claim 2, wherein
the hash value calculation unit calculates the hash value for the target warning using, as inputs, the warning related data, code in a warning related line from which the target warning is detected, and code in another line related to the warning related line within the source code.

6. An analysis result management method managing, using an analysis result management device, data of static analysis results obtained by analyzing source code using different analysis tools, the analysis result management method being implemented by a computer and comprising:
preparing, with the analysis result management device, a table including multiple different warning descriptions, which are generated by analyzing a same type of warning by the different analysis tools, the table further including identification information that is associated with each of the multiple different warning descriptions;
receiving, with the analysis result management device, the data of static analysis results of the source code analyzed by the different analysis tools;
acquiring, with the analysis result management device, warning related data, which includes information related to a target warning included in the received static analysis results;
calculating, with the analysis result management device, a hash value for the target warning by referring to the table, the target warning being a warning for which the hash value is to be calculated;
in response to determining that one of the multiple different warning descriptions corresponds to the target warning, calculating the hash value for the target warning using the identification information associated with the one of the multiple different warning descriptions in the table, without using the one of the multiple different warning descriptions;
storing, in a database, data of the target warning in association with the hash value calculated for the target warning; and
displaying the data stored in the database.

7. A computer-readable non-transitory storage medium storing a computer program, which includes instructions for managing data of static analysis results obtained by analyzing source code using different analysis tools, the instructions of the computer program comprising:
preparing a table including multiple different warning descriptions, which are generated by analyzing a same type of warning by the different analysis tools, the table further including identification information that is associated with each of the multiple different warning descriptions;
receiving the data of static analysis results of the source code analyzed by the different analysis tools;
acquiring warning related data, which includes information related to a target warning included in the received static analysis results;
calculating a hash value for the target warning by referring to the table, the target warning being a warning for which the hash value is to be calculated;
in response to determining that one of the multiple different warning descriptions corresponds to the target warning, calculating the hash value for the target warning using the identification information associated with the one of the multiple different warning descriptions in the table, without using the one of the multiple different warning descriptions;
storing, in a database, data of the target warning in association with the hash value calculated for the target warning; and
displaying the data stored in the database.
